(19) United States
(12) Patent Application Publication
(10) Pub. No.: US 2025/0374871 A1
(43) Pub. Date: Dec. 11, 2025

(54) GRID TRELLISING SYSTEM FOR GRAPE VINES AND RELATED METHODS

(71) Applicants: Jon Basila, Madera, CA (US); Paul Basila, Madera, CA (US)

(72) Inventors: Jon Basila, Madera, CA (US); Paul Basila, Madera, CA (US)

(21) Appl. No.: 19/232,755

(22) Filed: Jun. 9, 2025

Related U.S. Application Data
(60) Provisional application No. 63/657,123, filed on Jun. 7, 2024.

(51) Int. Cl. A01G 17/06; A01D 46/26; A01D 46/28; A01G 17/00

(52) U.S. Cl. CPC A01G 17/06; A01D 46/264; A01D 46/28; A01G 17/005; A01G 2017/065

(57) ABSTRACT

A trellis and DOV grape growing system utilized for grape vines, featuring an overhead training wire system that allows for the positioning of canes in a multi-quadrant arrangement. The canes are supported by posts positioned along adjacent rows of vines. The system includes a network of training wires which allow the canes to be directed in multi-axial directions from each vine. The trellis system allows the grapes to desiccate under solar warmth while on the vine, thus forming raisins. The DOV grapes may then be efficiently harvested by a vehicle having a canopy-shaking apparatus passing under the trellis canopy.

### FIELD OF THE INVENTION

The present invention pertains generally to support structures and devices, and more particularly to an agricultural trellis system and method for use in supporting plants, vines, stalks, and the like.

### DISCUSSION OF THE BACKGROUND

Trellis systems, essential in agriculture for supporting vine growth, are pivotal for producing wine grapes, table grapes, raisins, and other vine-derived fruits. Traditionally, these systems comprise a series of vertical supports or posts, with one or more horizontal trellis wires strung at selected heights along the row of posts to support the vines. However, despite their prevalence, there has been a notable absence of trellis systems incorporating an overhead grid of training wires. Such an overhead grid could potentially offer superior support and space utilization, allowing for more effective vine training and fruit production. Cross arm structures may complement these vertical stakes, enabling various trellis configurations to optimize vineyard performance.

A commonly used trellis system in commercial grape cultivation is the single vertical shoot propagation (VSP) method, characterized by trellis wires aligned within a vertical plane established by a row of posts or stakes. In this system, the vine cordons are trained horizontally along the wires in the vertical plane, with the fruit typically situated along the same plane. While this setup is straightforward to install and facilitates machine harvesting, it notably lacks an overhead grid of training wires. The absence of such an overhead structure means that the vines are restricted to vertical growth, potentially limiting exposure to sunlight and air circulation compared to systems that incorporate an overhead trellis, which could improve canopy management and fruit quality.

There is accordingly a need for trellising systems and methods that provides improved vine support, sun exposure, and fruit production. The present invention satisfies these needs, as well as others, and generally overcomes the deficiencies found in the background art.

### SUMMARY OF THE INVENTION

The present invention relates to a versatile trellis system equipped with an overhead grid of training wires, designed for cultivating various types of grapes. This system features a grid canopy configuration that spans over a plurality of rows of grape vines, accommodating canes positioned in a multi-axial arrangement of cordons that spread the arms canes over the passage between the rows of vines and allows for harvesting from the space between the rows. The novel multi-axial arrangement of cordons also provides more area for the growth of the cordons, arms, and canes of the vines, which may provide more yield.

The trellis structure may include a gride of wires that include wires parallel to the rows of vines and cross wires that run perpendicular to the rows of vines. The parallel and cross wires may be interwound or otherwise bound to provide a stable structure on which the cordons, canes, and arms can be grown in a multi-axial, radiating pattern from each vine in order to place the growing grapes over the spaces between the vine rows and to maximize the area over which the grapes can be grown. The canes may be arranged such that they are spaced evenly in a radiating pattern. For example, the canes may be trained in a four-cane “quadrilateral” pattern with the canes spaced at about 90° from the next. The trellis system may further include oblique wires that pass over and/or under the parallel and cross wires at oblique angles and may be interwound or otherwise bound to parallel and cross wires to provide additional support for the cordons, canes, and arms. The space between the rows and the spacing between the parallel wires may be in a range of about 3 feet to about 12 feet. In some embodiments, there may be additional parallel wires that run between the rows of vines. The cross wires may be spaced apart in a range of about one foot to about 10 feet. The oblique wires may parallel to one another and may be spaced apart in a range of about two feet to about 10 feet.

The trellis system includes vertical posts at intervals along the rows of vines to provide the support to hold the wire gride above the vines at an elevation that will allow the passage of trailers or harvesters to pass underneath and collect grapes or raisins from the vines in space between the rows. The vertical posts may be positioned at intervals along a row of vines of about 5 feet to about 20 feet. In some embodiments, the vertical posts may support the wire grid at a height in a range of about five feet to about 10 feet. At least a portion of the parallel wires may be connected at or near the upper end of the vertical posts. At least a portion of the cross wires may be connected at or near the upper end of the vertical posts. In some embodiments all of the parallel wires are connected at or near the upper end of the vertical posts. In some embodiments all of the cross wires are connected at or near the upper end of the vertical posts. In some embodiments, at least a portion of the oblique wires are connected at or near an upper end of the vertical posts. In some embodiments, all of the oblique wires are connected at or near an upper end of the vertical posts. The more connections between the vertical posts and the wire grid, the more stable the wire grid may be.

In some embodiments, the trellis system may include parallel beams between the vertical posts to provide further support to the wire grid. The parallel, cross wires, and/or the oblique wires may be bound or otherwise connected to the parallel beams of the trellis system. In some embodiments, cross arms may be positioned at the upper end of the vertical posts in order to provide a further support for the parallel, cross, and/or oblique wires and a structure to attach the wire grid.

In some embodiments, there may be endposts at the end of each row in the vine trellis system to provide enhanced stability and support. The endposts may be made from treated wood, metal, or reinforced plastic, and they bear the tension from the grid wires. Anchor systems, such as deadman anchors, auger anchors, or concrete anchors, may secure these end posts to the ground, preventing them from leaning or moving. Additionally, braces or stays, which can be H-braces or diagonal braces, may extend from the end post to provide further stability. These braces may ensure that the end posts remain upright and secure, even under the tension of the wires. Turnbuckles or other tensioning devices may also attached the end posts and wires in the wire grid (e.g., parallel wires) to adjust the wire tension to accommodate vine growth and changes in temperature. Together, these components create a strong and stable foundation for the trellis system, ensuring it can support the multi-axial vine growth effectively.

The overhead wire grid provides support for cordons and the fruiting canes growing therefrom, allowing for grape growth over the spaces between rows, thereby increasing the area over which the grapes are grown and the potential yield of the grape crop. Additionally, the growth of the grapes over the spaces between the rows facilitates harvesting of raisins from dry-on-the-vine (DOV) varieties of raisin grapes. The DOV grapes can be harvested from the wire grid of the present invention by (1) positioning a bin or other receptacle under the wire grid in the space between the rows and (2) shaking the wire grid with a shaking device to dislodge the raisins from the canes to drop into the bin or other receptacle. For example, the present trellis system may be used in connection with grapes of the variety Vitis vinifera L. (“Sunpreme”) grapevines, which produce DOV grapes that are particularly easy to shake from the canes of the vines. Thus, the present trellising system enables efficient DOV raisin production and harvesting. The overhead trellis system not only supports diverse grape varieties but also accommodates optional DOV trellising methods, enhancing versatility and productivity.

Harvesting dry-on-the-vine (DOV) grape varieties from the trellising system of the present invention may utilize specialized mechanical shakers that are designed to efficiently remove DOV grapes from the vine while minimizing damage to both the fruit and the plant. A canopy shaker may be used to dislodge the DOV grapes. Canopy shakers are designed to gently shake the grapevine canopy with padded rods or fingers that vibrate to loosen the grapes, causing them to detach and fall into a collection bin or other receptacle. In some embodiments, the rods strike the fruit zone vertically from below, shaking the grapes loose, as the harvester moves along the row. The detached grapes may be otherwise be collected on conveyor belts or catch trays, which transport them to bins or trailers for further processing. The canopy shaker may pass below the canopy between the rows vines, collecting the DOV grapes in one pass without the grapes falling to the ground. The harvesters may be self-propelled and, in some embodiments, may include automated systems that navigate the harvester through the areas between rows and apply the shaking mechanism. The combination of the present trellising system and the canopy shaker provides a highly efficient process for growing, drying, and harvesting DOV grapes.

Alternatively, the canopy may be shaken with a manual tool, such as a pole shaker, handheld vibrator, or a rod or hook. These tools can be used in combination with a manually propelled or mechanized bin or collection receptacle placed under the canopy. By utilizing trellising systems with canopies between rows of vines, these harvesting methods can be applied effectively to ensure a streamlined and productive harvest process

The overhead canopy wire grid trellis and vine training system of the present invention offers several advantages over the traditional trellising methods
a. Improved Light Exposure: An overhead grid allows for a more even distribution of sunlight across the canopy. This can lead to better photosynthesis, which is crucial for the growth and development of the grapevines and the maturation of the fruit.
b. Enhanced Canopy Management: With an overhead grid, growers have more flexibility in managing the canopy. It allows for easier trimming, thinning, and training of the vines, leading to a more controlled and efficient growth pattern. This can result in better air circulation within the canopy, reducing the risk of fungal diseases that thrive in moist, poorly ventilated conditions.
c. Increased Yield Potential: The overhead system can support more extensive vine growth, allowing for higher planting density or more fruitful shoots per vine. This can ultimately lead to increased yield without compromising fruit quality.
d. Better Fruit Quality: The improved microclimate around the grape clusters, due to better sunlight and air exposure, can enhance fruit quality. Factors such as sugar content, acidity, and phenolic compounds can be positively affected, which is crucial for premium wine production.
e. Easier Mechanization: Overhead systems can be designed to accommodate mechanical harvesting more efficiently than VSP systems, reducing labor costs and time. They also facilitate other mechanized operations like pruning, spraying, and canopy management.
f. Durability and Longevity: An overhead grid system, being more robust, can withstand environmental stressors better than VSP systems. This can lead to a longer lifespan of the trellis structure and reduced maintenance costs over time.

The present invention provides an improved grape trellising system that includes an overhead wire grid that enables the growing of grapes in a multi-axial, radiating arrangement that allows growth over the space between rows and harvesting from the spaces between rows. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

### BRIEF DESCRIPTION OF THE DRAWING

FIG. 1 shows a perspective view of the overhead trellis system according to an embodiment of the present invention.

FIG. 2 shows a side view perspective of the overhead trellis system according to an embodiment of the present invention.

FIG. 3 shows a side view perspective of the overhead trellis system according to an embodiment of the present invention.

FIG. 4 shows a side view perspective of the overhead trellis system according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

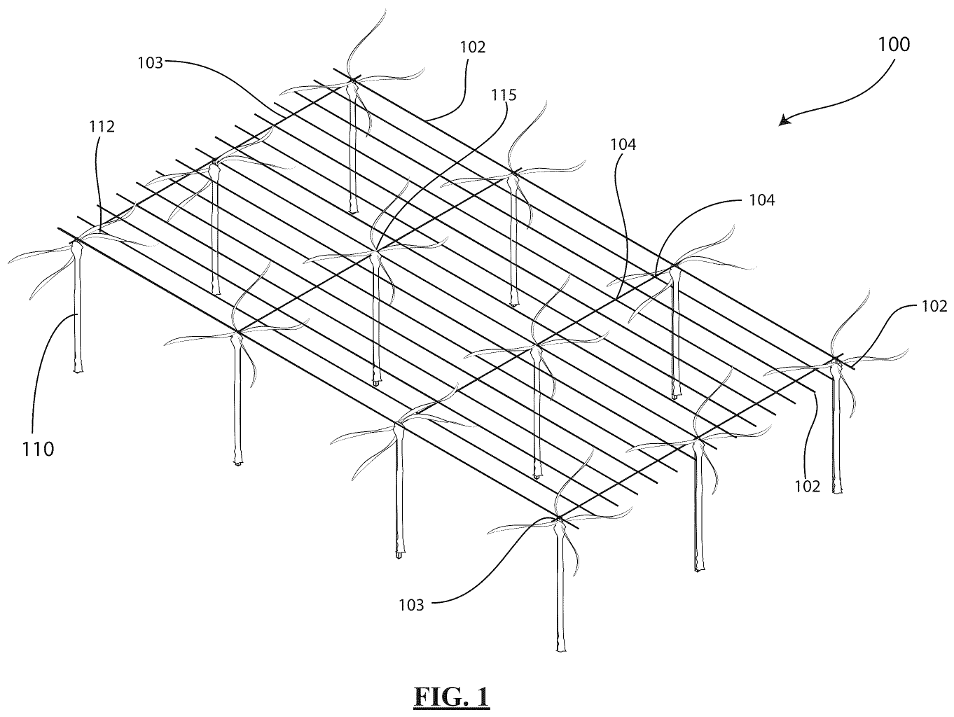

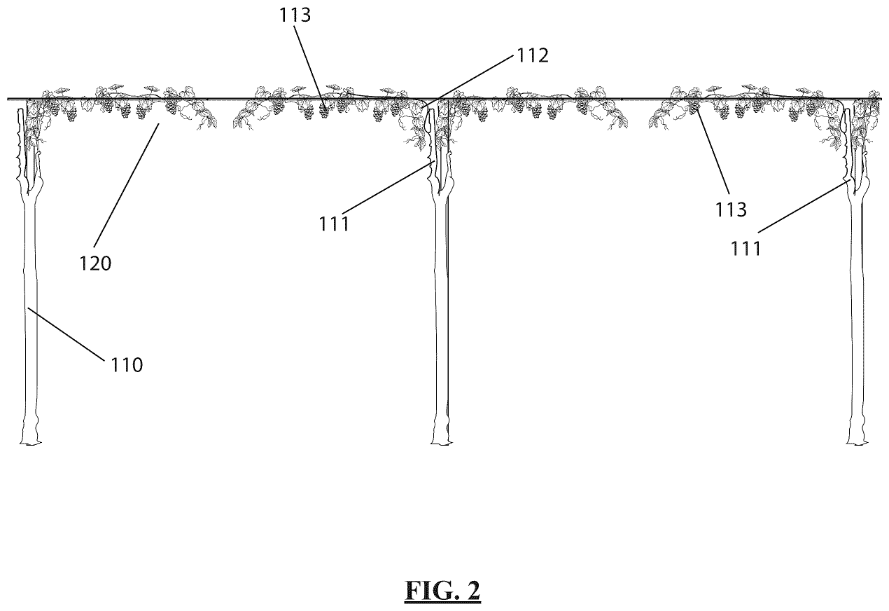

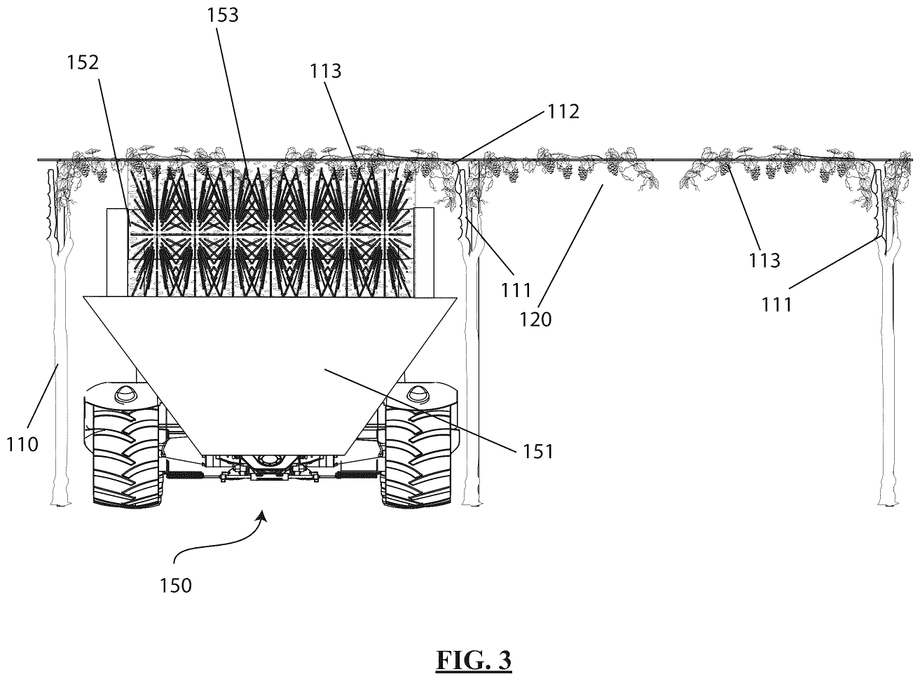

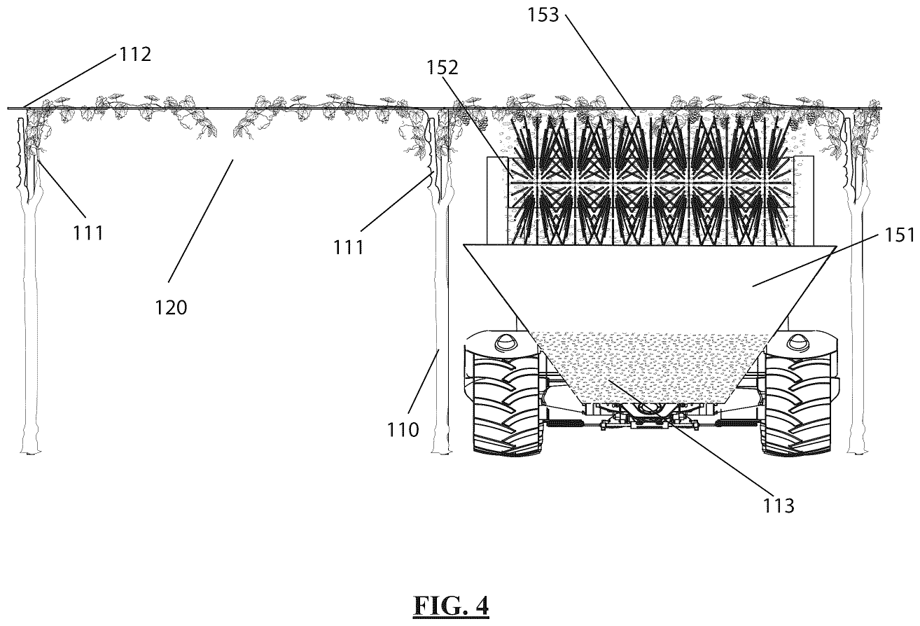

As shown in FIGS. 1-4, the present invention relates to an advanced trellis system (100) for grape vines, designed to enhance the efficiency of grape cultivation and harvesting by employing an overhead grid of training wires. This system, which integrates innovative structural and functional elements, aims to address the limitations of traditional trellis systems, thereby improving vine support, sunlight exposure, air circulation, and overall fruit production. The trellis system (100) is primarily supported by a series of vertical posts (101), positioned at intervals along the rows of grape vines (110). These posts provide the necessary height and stability to maintain the overhead grid of wires, ensuring that the system can support the weight of the growing vines and withstand environmental stressors.

The overhead grid comprises parallel wires (102) and cross wires (103) that intersect at nodes (104). This grid structure creates a stable and supportive framework for the vine cordons (111), canes (112), and arms (113). The parallel wires (102) run substantially parallel to the rows of grape vines (110), while the cross wires (103) run perpendicular to the rows, forming a lattice-like configuration. The nodes (104) between the parallel wires (102) and cross wires (103) provide stability of the grid, providing anchoring points where the wires are interconnected. This interwoven design ensures that the grid can support the multi-axial, radiating growth of the vines, allowing them to spread out in various directions and maximizing the area available for grape production. The trellis system may also include oblique wires, which run at oblique angles to the parallel wires (102) and cross wires (103), providing extra support and stability to the vine canopy. The oblique wires may be spaced apart by about 3 feet to about 10 feet.

The stability of the trellis system (100) may be further reinforced by additional structural elements. End posts, positioned at the ends of each row of grape vines (110), provide extra support and stability. These end posts are anchored to the ground using anchor systems, such as deadman anchors, auger anchors, or concrete anchors, preventing them from leaning or moving under the tension of the wires. Braces or stays, which can be H-braces or diagonal braces, extend from the end posts to provide further stabilization. These braces ensure that the end posts remain upright and secure, even under the tension of the wires. Turnbuckles or other tensioning devices attached to the end posts and wires allow for the adjustment of wire tension, accommodating vine growth and changes in temperature.

In some embodiments, the trellis system (100) includes parallel beams positioned between the vertical posts (101). These beams provide additional support to the overhead grid of wires, further enhancing the stability of the system. The parallel beams can be connected to the parallel wires (102) and cross wires (103) may add stability to the overall trellis structure. Cross arms may also be positioned at the upper end of the vertical posts (101). These cross arms offer additional support and attachment points for the overhead grid of wires, distributing the weight of the vines and grapes more evenly across the structure. The cross arms can also be used to attach oblique wires running at oblique angles to the parallel wires (102) and cross wires (103).

The grape vines (110) are trained to grow along the overhead grid, with the cordons (111) extending horizontally and obliquely across the wires in order to spread the canes out radially to allow maximized area into which the canes, arms, and fruit can grow to maximize yield. The canes (112), which are the fruit-bearing branches, grow from the cordons and are supported by the grid structure. The arms (113) of the vines further extend from the canes, creating a dense canopy that benefits from enhanced sunlight exposure and air circulation. This arrangement allows the grape bunches (120) to hang freely from the canes (112), positioned over the pathways (140) between vine rows (130). The positioning of the grape bunches (120) over these pathways (140) facilitates easier access for harvesting vehicles (150), which can pass underneath the overhead grid to collect the grapes without damaging the vines.

The trellis system (100) is designed to accommodate various harvesting methods, including mechanized harvesting. A harvesting vehicle (150) is equipped with a bin (151) for collecting grapes and an oscillating harvesting brush (152). This brush features harvesting rods (153) that gently shake the grape bunches (120), causing them to detach from the canes (112) and fall into the bin (151). The oscillating motion of the harvesting brush (152) may be calibrated to minimize damage to the grape bunches (120) and the vine structure. The harvesting rods (153) can be adjusted to target specific areas of the canopy, ensuring an efficient and thorough harvest. The design of the trellis system (100) allows the harvesting vehicle (150) to navigate easily between the vine rows (130), enhancing the speed and effectiveness of the harvesting process.

### Method of Growing and Harvesting DOV Grapes

The present invention provides a novel method for growing, drying, and harvesting grapes using the trellis system (100), which provides novel vine training, canopy coverage, and efficient harvesting, which maximizes yield and fruit quality. The process begins with the installation of vertical posts (101) at regular intervals along the rows of grape vines (110) and the grid wires are strung between the vertical posts over the vine rows and pathways.

The vine cordons (111) are trained to grow horizontally along the parallel wires (102), while the fruit-bearing canes (112) are directed to grow in a multi-axial, radiating pattern from the cordons. The canes may be evenly spaced from one another in a radiating pattern in order to maximize the space between the canes to provide maximum space between the canes, while maximizing canopy coverage and yield. In some embodiments, four canes from each vine may be trained in a quadrilateral pattern, with each cane being spaced from the next by an angle of about 90°. The canes (112) may be attached to the grid wires using various binding devices, such as garden tape, wire ties, twine, or other appropriate binding devices. This method maximizes canopy coverage by allowing the canes to spread over the space between the vine rows (140), enhancing light exposure and air circulation.

The arms (113) of the grape vines extend from the canes (112), forming a dense canopy supported by the overhead grid. Ensuring that the arms are evenly distributed across the grid, utilizing the nodes (104) as anchor points, helps create an optimal microclimate for the grapes. The multi-axial, radiating arrangement of the canes (112) and arms (113) allows the grape bunches (120) receive even sunlight exposure, which is crucial for photosynthesis, enhancing vine growth and fruit maturation.

The overhead grid system (100) promotes better air circulation within the canopy, reducing the risk of fungal diseases and other moisture-related issues, leading to healthier vines and better-quality grapes. For grape varieties intended for raisins, such as Vitis vinifera L. (“Sunpreme”), the overhead grid facilitates the drying process. The grapes are left to desiccate naturally on the vine under solar warmth. The design of the trellis system (100) allows the grapes to dry effectively while still attached to the canes (112), improving the quality and consistency of the raisins.

When preparing for harvest, the harvesting vehicle (150) is positioned in the paths between vine rows (140). This vehicle is equipped with a bin (151) for collecting the grapes and an oscillating harvesting brush (152). The oscillating harvesting brush (152) features harvesting rods (153) that gently shake the grape bunches (120), causing them to detach from the canes (112) and fall into the bin (151). The harvesting rods (153) are designed to minimize damage to the grapes and the vine structure.

The harvesting vehicle (150) moves systematically along the paths between vine rows (140), ensuring that the grape bunches (120) are shaken loose by the harvesting rods (153) and collected efficiently by the bin (151) positioned below the harvesting brush (152). The overhead grid (100) is elevated to allow the vehicle to pass underneath without obstructing the canopy. As the harvesting vehicle progresses, the detached grapes fall into the bin (151), which can be periodically emptied into larger containers or trailers for transport to processing facilities.

After harvesting, the trellis system (100) may be inspected for any damage or wear. Any loose wires may be tightened using the tensioning devices attached to the end posts. Routine maintenance on the vertical posts (101) and other structural components ensures the system remains stable and effective for future growing seasons.

The Sunpreme grape variety is particularly advantageous to use with the trellis system and method of the present invention due to its suitability for dry-on-the-vine (DOV) raisin production. The overhead grid structure of the trellis system enhances sunlight exposure and air circulation, which are critical for drying grapes directly on the vine. Sunpreme grapes, known for their ease of detachment when shaken, benefit from the system's efficient harvesting process. The combination of improved drying conditions and efficient mechanical harvesting provided by the trellis system maximizes yield, fruit quality, and overall productivity of Sunpreme grapes.

In summary, the method for growing, drying, and harvesting grapes using the trellis system (100) of the present invention offers significant advantages over traditional methods. By employing an overhead grid of wires and a multi-axial, radiating training pattern, this method maximizes canopy coverage, enhances sunlight exposure, and improves air circulation. The efficient harvesting process, facilitated by the specialized harvesting vehicle (150), ensures that the grapes are collected with minimal damage, resulting in higher quality fruit and increased yield. This comprehensive approach to viticulture not only boosts productivity but also ensures the long-term health and sustainability of the vineyard.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A trellising and grape growing system for cultivating grape vines, comprising:
a. a trellis structure having
i. plurality of vertical posts positioned at intervals along rows of grape vines, each vertical post having an upper end;
ii. an overhead grid of wires supported by the vertical posts, the grid including:
1. parallel wires running substantially parallel to the rows of vines, and
2. cross wires running substantially perpendicular to the rows of vines, wherein the parallel wires and cross wires are connected to form a stable structure for supporting the growth of vine cordons, canes, and arms in a radiating arrangement; and
b. a plurality of vines of a dry-on-the-vine (DOV) grape variety trained on the trellis structure with canes positioned on cross wires and over spaces between a plurality of rows of the vines.

2. The system of claim 1, further comprising end posts positioned at the end of each row to provide stability to the trellis system, the end posts being anchored to the ground with anchor systems, braces or stays extending from the end posts to further stabilize the trellis system, turnbuckles or other tensioning devices attached to the end posts and wires for adjusting the tension of the wires.

3. The system of claim 1, further comprising oblique wires running at oblique angles to the parallel and cross wires, the oblique wires being substantially parallel to one another.

4. The system of claim 1, wherein the overhead grid of wires is elevated above the rows of grape vines at a height that allows the passage of trailers or harvesters underneath for collecting grapes or raisins from the space between the rows.

5. The system of claim 1, further comprising parallel beams between the vertical posts for additional support to the overhead grid of wires.

6. The system of claim 1, further comprising cross arms are positioned at the upper end of the vertical posts to provide further support and attachment for the overhead grid of wires.

7. The system of claim 1, wherein in the DOV grapes comprise the Vitis vinifera L. variety.

8. A method for growing grape vines on a trellis system, comprising:
a. installing a plurality of vertical posts at intervals along rows of grape vines;
b. supporting an overhead grid of wires on the vertical posts, the grid comprising connected parallel wires and cross wires to form a stable structure;
c. spacing rows of grape vines and the parallel wires to allow for the passage of trailers or harvesters underneath the overhead grid;
d. training the cordons and canes of grape vines to grow in a multi-axial arrangement over the overhead grid of wires, including over spaces between the rows of grave vines.

9. The method claim 8, further comprising anchoring end posts at the end of each row and securing them with anchor systems to provide stability to the trellis system, and adjusting the tension of the wires using turnbuckles or other tensioning devices.

10. The method claim 8, further comprising oblique wires in the overhead grid of wires.

11. The method of claim 8, further comprising installing parallel beams between the vertical posts to provide additional support to the overhead grid of wires.

12. The method of claim 8, further comprising attaching cross arms at the upper end of the vertical posts to support and attach the overhead grid of wires.

13. The method of claim 8, further comprising shaking the overhead grid of wires with a shaking device to dislodge raisins from the canes for harvesting.

14. The method of claim 8, wherein the grape vines are of a dry-on-the-vine (DOV) variety.

15. The method of claim 14, wherein in the DOV grapes comprise the Vitis vinifera L. variety.

16. A method for growing grape vines on a trellis system, comprising:
a. positioning a plurality of vertical posts at intervals along rows of grape vines of a dry-on-the-vine (DOV) variety;
b. supporting an overhead grid of wires on the vertical posts, the grid comprising parallel wires and cross wires interwound or otherwise bound to form a stable structure;
c. training the cordons, canes, and arms of the grape vines to grow in a multi-axial arrangement over the overhead grid of wires;
d. spacing the rows of grape vines and the parallel wires to facilitate harvesting from the space between the rows; and
e. harvesting the grapes by positioning a receptacle under the overhead grid and shaking the grid to dislodge the grapes into the receptacle.

17. The method of claim 16, further comprising attaching cross arms at the upper end of the vertical posts to support and attach the overhead grid of wires.

18. The method claim 16, further comprising anchoring end posts at the end of each row and securing them with anchor systems to provide stability to the trellis system, and adjusting the tension of the wires using turnbuckles or other tensioning devices.

19. The method claim 16, further comprising oblique wires in the overhead grid of wires.

20. The method of claim 16, further comprising installing parallel beams between the vertical posts to provide additional support to the overhead grid of wires.

21. (canceled)
